(19) United States
(12) Patent Application Publication
(10) Pub. No.: US 2007/0053754 A1
(43) Pub. Date: Mar. 8, 2007

(54) Universal quick flex and method of use

(76) Inventors: Clinton Hartranft, Slatington, PA (US); Patricia Hartranft, Slatington, PA (US)

Correspondence Address: Galasso & Associates, LP, P. O. Box 26503, Austin, TX, 78755-0503, US

(21) Appl. No.: 11/222,309

(22) Filed: Sep. 8, 2005

(51) Int. Cl. B23B 45/00

(52) U.S. Cl. 408/127

(57) ABSTRACT

A drill accessory comprising an extended flexible inner shaft encased by a rubber outer casing. This accessory comprises an attachment operable to attach to a power source on one end and a quick release chuck and/or a keyless chuck on the opposite end that allows a wide range of drilling devices to be attached. The accessory is attached to a power source and can be bent at various points to allow a user to reach areas that might otherwise be unreachable. The outer rubber casing is a safety feature for working around electricity. A brace can be added in the area of the quick release chuck to the accessory which operates to provide stability or alternatively, the accessory comprises a front collar wherein a plastic grip can be attached or removed as necessary.

### FIELD OF THE DISCLOSURE

The universal quick flex is a flexible drill attachment capable of extending a drilling device into small areas.

### BACKGROUND

Drilling holes in small or tight places has been a problem that has existed for years. Electric drills are a great improvement over the hand drills that were most commonly used in the past. Unfortunately, electric drills are not the cure all for all situations. They tend to be bigger and more bulky than hand drills. Since they are bulky and require a certain amount of space for getting the drill at the proper angle, there are areas where you are not able to use an electric drill. Examples of various types of electric drills are disclosed in U.S. Design Patent D486,049, U.S. Pat. No. 4,751,452 and U.S. Pat. No. 6,155,576. All of these patents disclose an electric type drill operable to attaching a drill bit. U.S. Pat. No. 6,155,576 discloses a device operable to accept a wide range of tool shank diameters and is particularly designed to accept larger diameter tool shank devices.

Hand drills are not always the best answer for drilling holes either. They require enough space to get the drill into the area where you need to drill and enough space to actually turn the drill shaft causing the hole to be drilled. Additionally, hand drills have a solid, non-flexible shaft which is rotated in a circular motion causing the drill bit to circulate in the same circular motion. Due to the non-flexible shaft there are number of small places where you cannot use a hand drill.

For example, depending on the width of studs in buildings, you may not be able to get a hand drill at the proper angle to drill a hole in the side of a stud.

Electric screw drivers come in all types and sizes. Now that they make drill bits that are attachable to electric screw drivers this alleviates some of the problems but not all of them. While some electric screw drivers are smaller and less bulky than others, they too have a solid shaft area that is not flexible.

There are certain types of socket wrenches that would allow you to attach a drill bit. Once the drill bit is attached to the socket, you could attach a certain amount of extensions some of which create angles. Of course the problem with this type of situation is that the more extensions you attach, the more leverage you loose. In addition, extensions for socket wrenches come in different specified lengths, therefore, you have to hope you have or they make the proper lengths for each required job.

### SUMMARY OF THE DISCLOSURE

In one embodiment of the present invention the tool extension comprises a flexible inner shaft.

In another embodiment the flexible inner shaft comprises a first end and a second end.

In yet another embodiment the first end of the flexible inner shaft is operable to attach to a power source.

In another embodiment the flexible inner shaft is operable to rotate.

In still another embodiment the flexible inner shaft is encompassed within a rubber coated casing.

In yet another embodiment the flexible inner shaft comprises a front collar.

In still another embodiment the front collar is capable of having a plastic grip attached.

In another embodiment the front collar operable to provide stability.

In another embodiment the second end of the flexible inner shaft is attached to a quick release chuck.

In yet another embodiment the quick release chuck is operable to attach to a keyless chuck.

In still another embodiment the quick release chuck is operable to attach to a drilling/screwing agent.

In another embodiment the cross bracket is capable of being inserted between the quick release chuck and the keyless chuck.

In yet another embodiment the cross bracket is operable to provide stability.

In still another embodiment the keyless chuck is operable to attach to a drilling/screwing agent.

In yet another embodiment the quick release chuck and the keyless chuck are operable to rotate in conjunction with the flexible inner shaft.

In still another embodiment the flexible inner shaft measures between 12 and 18 inches in length.

### BRIEF DESCRIPTION OF THE DRAWINGS

FIG. 1 illustrates a perspective view of a universal quick flex.

FIG. 2 illustrates a perspective view of the optional plastic grip.

FIG. 3 illustrates a front view of a cross bracket.

### DETAILED DESCRIPTION OF THE DRAWING FIGURES

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

FIG. 1 illustrates a universal quick flex comprising a tool extension 10, a flexible inner shaft 20, a rubber casing 30, a drill attachment 40, a front collar 50, a quick release chuck 60, a keyless chuck 70, a plastic grip 80 and a cross bracket 90. The tool extension 10 is designed to fit a power drill or electric screwdriver. The flexible inner shaft 20 is attached to the drill by the drill attachment 40. Once the flexible inner shaft 20 is attached to the drill, a drill bit or screwing device can be attached to the quick release chuck 60. Alternatively, a keyless chuck 70 can be attached to the quick release chuck 60 and then attach a drill bit or screwing device to the keyless chuck 70. Once the user has attached the necessary attachments, the drill is engaged causing the flexible inner shaft 20 to rotate which then causes the quick release chuck 60 to rotate and the keyless chuck 70 to rotate if it is attached to the quick release chuck 60. If the keyless chuck 70 is not attached to the quick release chuck 60, then the quick release chuck 60 will cause the drill bit to rotate. Otherwise, the drill bit will rotate when the keyless chuck 70 rotates in conjunction with the quick release chuck 60 and the flexible inner shaft 20.

The tool extension 10 is also designed with a rubber casing 30 encompassing the flexible inner shaft 20 as a safety feature when working around electrical components. Additionally, the front collar 50 is capable of having a plastic grip 80 attached to it. The plastic grip 80 would provide a non-slip surface in the event the user hands were wet or sweaty. Since the front collar 50 is designed to provide stability during the drilling process, it is even likely that a user might want the plastic grip 80 attached based on the drilling surface. A cross bracket 90 is operable to be placed between the quick release chuck 60 and the keyless chuck 70. It is also intended to be used to provide stability during the drilling process. Once the drilling process is completed the flexible inner shaft 20 can be removed from the drill. Also, the keyless chuck 70 can be removed from the flexible inner shaft 20. The keyless chuck 70 can then be used with other tools as needed.

By using the tool extension 10 in conjunction with a power source, the user is afforded the ability to reach drill holes or insert and remove screws in areas that might otherwise be impossible. Because the flexible inner shaft 20 is capable of being configured to reach into these areas it provides more flexibility to the user. It can not only be used for drilling, it can be used to extract screws or bolts from places where other tools might be unable to reach. Not only would the tool extension 10 be a good addition to a carpenter's tool box but it is capable of being used by mechanics as well. The flexibility of the flexible inner shaft 20 makes it possible to be able to reach around other objects for purposes of removing screws or the like.

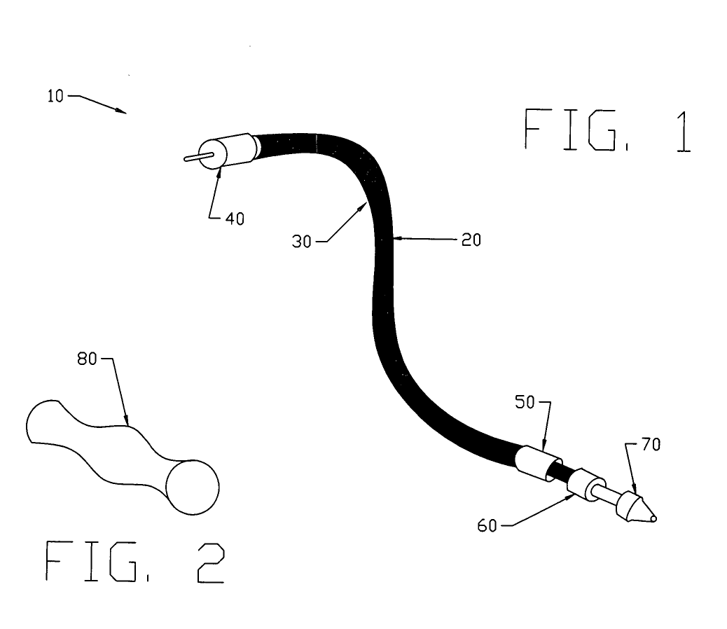

FIG. 2 illustrates a perspective view of the plastic grip 80 which can be placed around the front collar 50 or removed from the front collar 50 depending on the desired gripping preference.

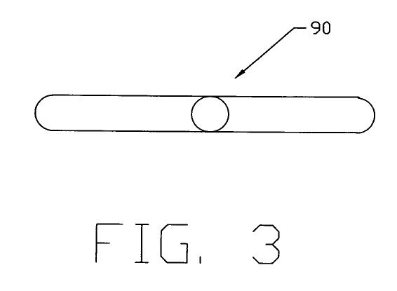

FIG. 3 illustrates a cross bracket 90 which is operable to be placed between the quick chuck 60 and the keyless chuck 70. The cross bracket 90 is designed to spin until the desired angle is reached. The cross bracket 90 is particularly good for providing stability when the drilling process is taking place between two stationary objects such as studs. The cross bracket 90 can be angled so that both sides are braced against the studs. Since the cross bracket 90 should be constructed of a non-bendable material, it is capable of providing stability for the tool extension 10 during the drilling process. If additional stability is required, then the use of the front collar 50 can still be used in conjunction with the cross bracket 90.

Although an embodiment of the present invention has been shown and described in detail herein, along with certain variants thereof, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention.

What is claimed:

1. A tool extension comprising:
a flexible inner shaft comprising a first end and a second end; and wherein said flexible inner shaft is operable to rotate when attached to a power source and said power source is engaged;
a rubber coated casing encompassing the flexible inner shaft;
a front collar attached to the rubber casing wherein a plastic grip can attach;
a quick release chuck attached to said second end of said flexible inner shaft; and
a keyless chuck attached to said quick release chuck.

2. A tool extension of claim 1, wherein said flexible inner shaft comprises a connection operable to connect to a power source on said first end.

3. A tool extension of claim 1, wherein said front collar is operable to provide stability.

4. A tool extension of claim 1, wherein said quick release chuck is operable to attach to a drilling/screwing agent.

5. A tool extension of claim 1, wherein a cross bracket can be inserted between said quick release and said keyless chuck.

6. A tool extension of claim 1, wherein said keyless chuck is operable to attach to a drilling/screwing agent.

7. A tool extension of claim 1, wherein said flexible shaft is between 12 inches and 18 inches in length.

8. A tool extension system comprising:
a flexible inner shaft comprising a first end and a second end; wherein said flexible inner shaft is encompassed in a rubber coated casing; and wherein said flexible inner shaft is operable to rotate when attached to a power source and said power source is engaged;
a front collar operable to attach a plastic grip; wherein said front collar is operable to provide stability during the drilling process;
a quick release chuck attached to said second end of said flexible inner shaft;
a keyless chuck attached to said quick release chuck and operable to attach to a drilling/screwing agent.

9. A tool extension system of claim 8, wherein said quick release chuck is operable to attach a drilling/screwing agent.

10. A tool extension system of claim 8, wherein said quick release chuck is operable to allow a cross bracket to be inserted before attaching said keyless chuck.

11. A tool extension system of claim 10, wherein said cross bracket operates as a support mechanism.

12. A method for drilling using a drilling device with an extension having a flexible inner shaft encompassed by a rubber coated casing and including a first end and a second end, said method comprising the steps of:
attaching the first end of the extension to a power source;
attaching a quick release chuck to the second end of the flexible inner shaft;
attaching a keyless chuck to the quick release chuck;
inserting a cross bracket between the quick release chuck and the keyless chuck;
inserting a drill bit into the keyless chuck;
placing the drill bit on a drilling surface and engaging the power ource causing the flexible inner shaft to rotate to thereby cause the quick release chuck and the keyless chuck to rotate the drill bit;
disengaging the power source and removing the drill bit from the drilling surface;
removing the drill bit from the keyless chuck; and
removing the flexible inner shaft from the power source.

13. The method of claim 12, further comprising the step of removing the cross bracket and keyless chuck.

14. The method of claim 12, further comprising the step of inserting the drill bit into the quick release chuck.
